(19) United States
(12) Patent Application Publication
(10) Pub. No.: US 2005/0238298 A1
(43) Pub. Date: Oct. 27, 2005

(54) Optical fiber fusion splicer with personal computer functionality

(76) Inventors: Bryan R. Roark, Hickory, NC (US); James G. Renfro JR., Hickory, NC (US); Bert Zamzow, Gauting (DE)

Correspondence Address: CORNING CABLE SYSTEMS LLC, P O BOX 489, HICKORY, NC, 28603, US

(21) Appl. No.: 11/111,118

(22) Filed: Apr. 21, 2005

Related U.S. Application Data
(60) Provisional application No. 60/564,859, filed on Apr. 23, 2004.

(51) Int. Cl. G02B 6/255

(52) U.S. Cl. 385/96

(57) ABSTRACT

An optical fiber fusion splicer includes a personal computer and splicing elements in communication with and controlled by the personal computer for fusion splicing at least one pair of opposed optical fibers. The personal computer is integral with the splicing elements within the fusion splicer and provides personal computer functionality to the fusion splicer. The fusion splicer may further include a hard drive in communication with the personal computer for storing and retrieving data, a display in communication with the personal computer including a graphical user interface comprising a touch screen and one or more icons for controlling the personal computer, and a global positioning system in communication with and adapted to interface with the personal computer to assist with fusion splicing the optical fibers. The fusion splicer may also include a central processing unit in communication with the personal computer and the splicing elements.

### CROSS-REFERENCE To RELATED APPLICATIONS

This application claims the benefit of priority under 35 U.S.C. § 119(e) of U.S. Provisional Application Ser. No. 60/564,859 filed on Apr. 23, 2004.

### BACKGROUND OF THE INVENTION

1. Field of the Invention

The present invention relates generally to an optical fiber fusion splicer that is preferably used in the field to splice optical fibers, and more particularly, to an optical fiber fusion splicer for splicing optical fibers in a fiber optic network where low loss performance is desired. The field fusion splicer includes a personal computer that allows interactive training, remote maintenance, and e-commerce functionality.

2. Technical Background

It is known to provide an optical fiber fusion splicer designed specifically for use in a controlled factory environment with external computing capability. Fusion splicers for splicing optical fibers in the field are also known. None of the known field fusion splicers, however, has the interactive communication and personal computing capability that is presently available for a factory fusion splicer. Furthermore, none of the known field fusion splicers includes the ability to quickly and accurately locate splice points and perform high-precision fusion splices in the field utilizing personal computer functionality.

Such a field fusion splicer would necessarily require a level of personal computer functionality that includes wireless communication, interactive training, and the ability to import and retrievably store splice plans on a storage medium, obtain maintenance and assistance from remote service centers, and generate a video record of a fusion splice event. Accordingly, the present invention is directed to an optical fiber fusion splicer with personal computer functionality including wireless communication and interactive training, which may be utilized in the field to locate splice points, perform a high-precision fusion splice and generate a video record of the fusion splice event.

### SUMMARY OF THE INVENTION

To achieve these and other advantages and in accordance with the purpose of the invention as embodied and broadly described herein, the invention is directed in one aspect to an optical fiber fusion splicer including at least a personal computer, splicing elements in communication with the personal computer to fusion splice at least one pair of opposed optical fibers, and a graphical user interface to control the personal computer.

In another aspect, the invention is directed to a portable field fusion splicer including a personal computer and splicing elements, the personal computer being integral with and in communication with the splicing elements within the fusion splicer to fusion splice at least one pair of opposed optical fibers, and a graphical user interface to control the personal computer.

In yet another aspect, the invention is directed to a portable field fusion splicer including a personal computer and splicing elements, the personal computer being integral with and in communication with the splicing elements within the fusion splicer to fusion splice at least one pair of opposed optical fibers, a graphical user interface to control the personal computer, and a global positioning system (GPS) adapted to interface with the personal computer to locate splice points and to assist with performing a high-precision fusion splice.

In yet another aspect, the invention is directed to a portable field fusion splicer including a personal computer, splicing elements, a splice controller in communication with the personal computer and the splicing elements to fusion splice at least one pair of opposed optical fibers, and a graphical user interface to control the personal computer.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary and explanatory embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various exemplary embodiments of the invention, and together with the description, serve to explain the principles and operations of the invention.

### BRIEF DESCRIPTION OF THE DRAWINGS

FIG. 1 is a schematic illustrating the arrangement and operation of an exemplary embodiment of an optical fiber fusion splicer according to the present invention;

FIG. 2 is a perspective view of an exemplary embodiment of a field fusion splicer that operates in accordance with the principles illustrated in FIG. 1;

FIG. 3 is a front view of the lower portion of the field fusion splicer of FIG. 2 showing the connector ports of the fusion splicer;

FIG. 4 is a right-hand side view of the field fusion splicer of FIG. 2;

FIG. 5 is a left-hand side view of the field fusion splicer of FIG. 2;

FIG. 6 is a rear view of the field fusion splicer of FIG. 2; and

FIG. 7 is schematic of another exemplary embodiment of a field fusion splicer according to the present invention.

### DETAILED DESCRIPTION OF EXEMPLARY EMBODIMENTS

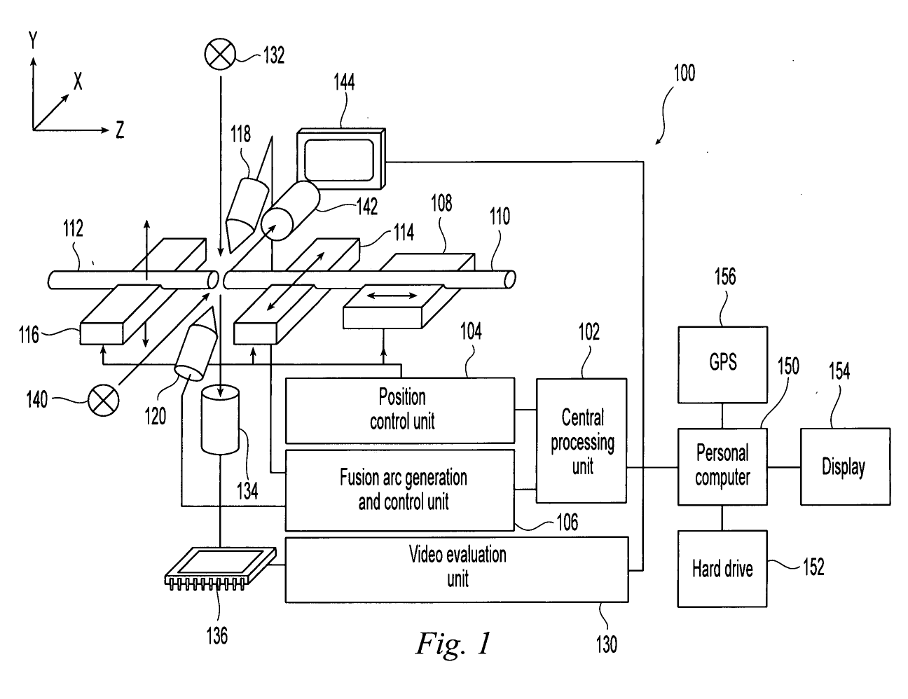

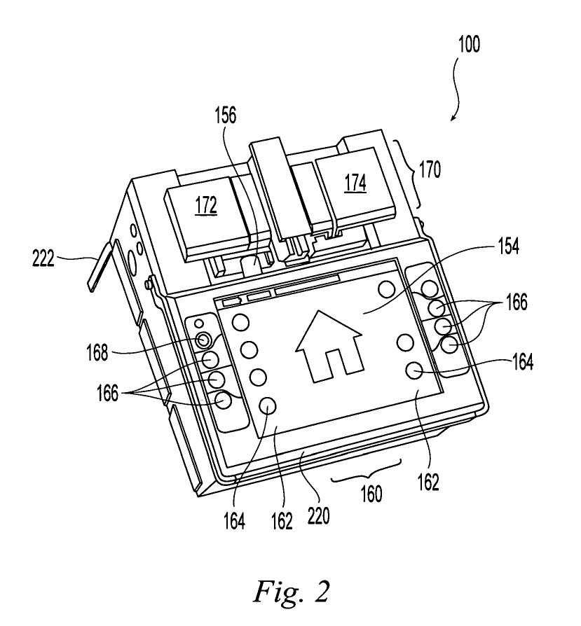

Reference will now be made in detail to exemplary embodiments of the invention, examples of which are described herein and shown in the accompanying drawings. Whenever practical, the same reference numerals are used throughout the drawings to refer to the same or similar parts or features. One embodiment of an optical fiber fusion splicer according to the present invention illustrated in FIG. 1 and shown in FIGS. 2-6 is designated generally throughout the following detailed description by the reference numeral 100.

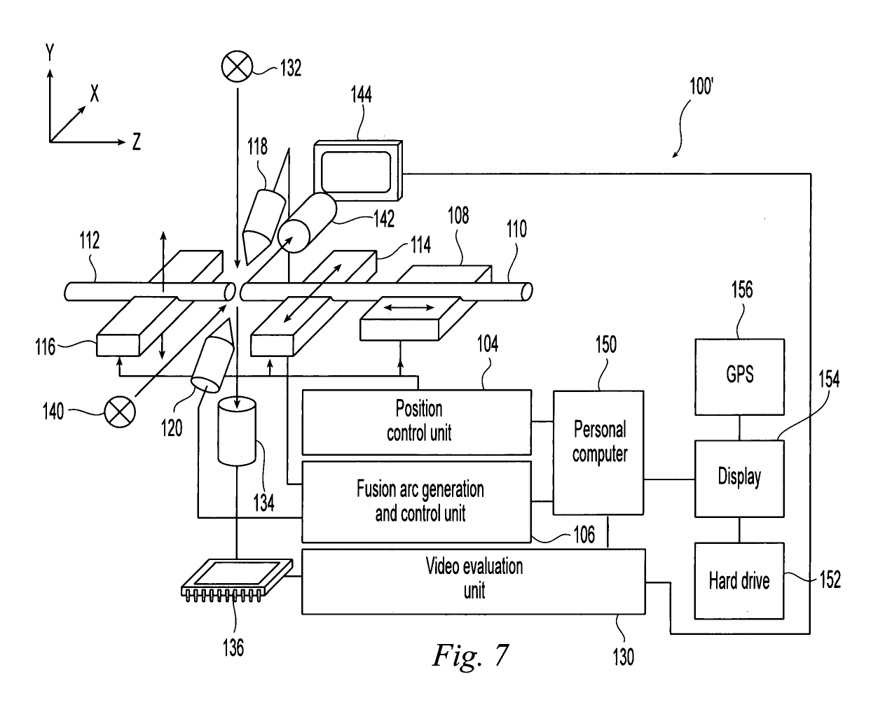

In accordance with the invention, an optical fiber fusion splicer 100 is illustrated schematically in FIG. 1. The fusion splicer 100 is a preferably a local injection and detection (LID) type fusion splicer, which injects light into at least one of a pair of opposed optical fibers 110,112 and positions the optical fibers relative to one another to optimize the fusion splice by maximizing the intensity of the transmitted light collected at a receiver (not shown). LID type fusion splicers are well known in the art and therefore the construction of the LID fusion splicer will not be described further except as necessary to explain the principles and operation of the present invention. As shown in FIG. 1 and described herein with respect to FIGS. 1-6, the fusion splicer 100 includes a central processing unit (CPU) 102 that interacts with a personal computer 150 to control the splicing functions of the fusion splicer 100. As is shown in FIG. 7 and will be described hereinafter, the fusion splicer 100 need not include the CPU 102 and the personal computer 150 may provide all of the capabilities and perform all of the functions of the CPU 102.

The CPU 102 controls a position control unit 104. As is well known in the art, the position control unit 104 controls the positioning units for the x, y, and z axes. It should be noted that the x, y, and z planes illustrated in FIG. 1 are assigned for ease of explanation, but they could be assigned according to any other preference. In conventional practice, the x and y axes may be rotated approximately forty-five degrees (45°) about the z axis from the configuration shown. As shown in FIG. 1, the z-axis positioning unit 108 moves one of the optical fibers 110 along the z-axis (in this Figure, the z-axis is oriented along the longitudinal axis of the optical fibers 110,112). Thus, the z-axis positioning unit 108 adjusts the axial distance between the optical fibers 110,112. The x-axis positioning unit 114 controls the lateral alignment of optical fiber 110 relative to optical fiber 112 along the x-axis, which in the embodiment shown is the axis perpendicular to the z-axis and extending into and out of the plane of FIG. 1. The y-axis positioning unit 116 is responsible for adjusting the vertical alignment of the optical fibers 110,112 by moving the second of the two optical fibers 112 relative to the first optical fiber 110 along the y-axis, which in the embodiment shown is the axis perpendicular to the z-axis and the x-axis and extending in the plane of FIG. 1.

The CPU 102 also controls a fusion arc generation and control unit 106. The fusion arc generation and control unit 106 in turn controls at least one, and as shown, a pair of fusion electrodes 118,120. When energized, the fusion electrodes 118,120 create an arc to heat and thereby fuse the optical fibers 110,112 to one another. While the general operation of the fusion electrodes 118,120 is well known, they may be configured with an electrode cleaning arc and arc-stabilizers that ensure reliability, durability and precision, in the manner described below.

The fusion electrodes 118,120 and their control unit 106, preferably in conjunction with the position control unit 104 and the x-axis, y-axis and z-axis positioning units 108,114,116, make up the splicing elements of the fusion splicer 100. Obviously, the positioning units 108,114,116 may be eliminated entirely and the optical fibers 110,112 provided with suitable support. Alternatively, the positioning units 108,114,116 may be manually operated rather than electrically operated, as shown. In the event the positioning units 108,114,116 are eliminated or manually operated, the splicing elements of the fusion splicer 100 would include only the fusion electrodes 118,120 and the fusion arc generation and control unit 106.

The CPU 102 also controls a video evaluation unit 130. The video evaluation unit 130 operates two video systems—namely an x-axis video system and a y-axis video system. The y-axis video system preferably includes a light source 132 to illuminate the optical fibers 110,112, an imaging system 134, and a camera chip 136 aligned with the imaging system 134 along the y-axis. Similarly, the x-axis video system preferably includes a light source 140 to illuminate the optical fibers 110,112, an imaging system 142, and a camera chip 144 aligned with the imaging system 142 along the x-axis. The two video systems generate a video record of the fusion splice event, as will be discussed in greater detail below. As is known in the imaging art, the function of the two video systems may be accomplished utilizing a single camera chip and a simple or complex lens depending upon the nature and quality of the video record desired.

The fusion splicer 100 also includes a personal computer (PC) 150, that preferably comprises a storage device, such as a hard drive 152, for storing and retrieving application software (e.g., a fusion splice program) and data. The hard drive 152 may be any of a conventional hard disk drive, Flash RAM chip or card, non-volatile RAM, memory stick or other device now known or hereafter devised for providing typical computer memory function. The PC 150 further includes a display 154 comprising a graphical user interface for graphically displaying the application software and data, and a global positioning system (GPS) 156. The GPS 156 may be configured with the PC 150 or may be a separate component that is in communication with the CPU 102 or with the PC 150 either directly or indirectly through the CPU 102. The PC 150 is in communication with the CPU 102 and interfaces with the CPU to optimize the fusion splice and thereby ensure that the optical power loss in the fusion splice is minimized. Typically, the PC 150 will be in electrical communication with the CPU 102. However, the PC 150 may advantageously be in wireless communication with the CPU 102, such as through a Bluetooth or wireless Local Area Network (LAN).

The PC 150 is preferably a fully operational personal computer that runs the same type of operating software as conventional personal computers, such as desktop, workstation and laptop computers. The operating software may include any of the known personal computer operating systems, such as Windows 2000® (available from Microsoft Corporation of Redmond, Wash.), Apple® or Linux. As described herein, the PC 150 utilizes the Windows XP® Professional operating system, which allows for the use of email, web browsing, and other personal computer functionality, as will be described in more detail below. The PC 150 also includes a suitable capacity hard drive 152 (preferably at least 1 GB, and more preferably at least about 10 GB) to store the operating and applications software, hardware drivers and any other computer software program needed or desired by the end user. The hard drive also stores instructional videos and data relating to the operating and applications software, including the fusion splice files and video files generated by the field fusion splicer 100 and described in greater detail below.

It should be noted that the PC 150 may by-pass the CPU 102 (and the CPU 102 may be eliminated) such that the PC 150 directly control all of the positioning, splicing and video functions in the fusion splicer 100. For example, in an alternative embodiment of the fusion splicer 100′ illustrated in FIG. 7, the PC 150 directly controls the position control unit 104 and fusion arc generation and control unit 106, in addition to the other components in the fusion splicer 100′. Thus, in the embodiment of FIG. 7, the PC 150 of fusion splicer 100′ physically and operationally replaces the CPU 102 of the embodiment illustrated in FIG. 1.

The display 154 for PC 150 is preferably a graphical display comprising a graphical user interface. In addition to the conventional touch screen features, the display 154 also allows for the use of on-screen keyboards and other intuitive interfaces with the end user. The display 154 is a video quality display having sufficient resolution capability for the end user to view interactive training videos stored on the hard drive 152 and any video records of the fusion splice event generated by the video evaluation unit 130.

A conventional GPS 156 is also provided in communication with the PC 150, giving the fusion splicer 100 several additional advantages over existing field fusion splicers. For example, the GPS 156 can be used to identify the physical location (i.e., longitude, latitude and altitude) of a splice point. Once the user is at the location of the splice point, the GPS 156 can be used to determine if there is a need to compensate for any effect of the altitude of the location. For example, at higher altitudes the parameters used to fuse the optical fibers may be different than at lower altitudes. The user may also incorporate mapping application software in conjunction with the GPS 156 and the PC 150 to facilitate voice navigation, navigating cable routes, or other advantageous features. The user may also store the longitude, latitude and altitude coordinates of the splice points determined by the GPS 156 on the hard drive 152 for verification and future reference. The GPS 156 also protects the field fusion splicer 100 by documenting the location of the equipment at all times. Thus, if the fusion splicer 100 is lost or stolen, its location may be traced and the equipment recovered using the GPS 156. One example of a GPS suitable for use with the present invention is shown and described in German Patent Application Number 10122840.6.

An exemplary embodiment of a fusion splicer 100 according to the schematic illustrated in FIG. 1 is shown in FIG. 2. The fusion splicer 100 has a display 154 including a graphical user interface comprising a conventional touch screen. As shown, the display 154 has a medial portion 160 for displaying video, computer software application and data information, and preferably at least one outer portion 162 on the touch screen for graphical icons 164 and other interactive icons. The icons 164 may be utilized by the end user to execute certain commands, such as “yes-no” or “on-off” commands to the different components of the fusion splicer 100. As shown in FIG. 2, the graphical user interface of display 154 preferably has two outer portions 162 for displaying icons 164 on the touch screen. The display 154 may also include one or more hard keys 166 having additional functions assigned to them by the operating system software or the applications software being used at any particular time. Typically, the function or feature of the hard keys 166 changes depending on the information displayed on the graphical user interface portion of the display 154. Preferably, a description of the function and/or the feature assigned to the hard keys 166 will appear on either the central portion 160 or on the outer portions 162 to assist the end user. The fusion splicer 100 may also include a dedicated “on-off” power button 168 among the hard keys 166. The touch screen buttons 164 and the hard keys 166 are used to control the PC 150, and therefore, fusion splicing of the optical fibers, either directly or through the CPU 102.

The fusion splicer 100 has a splicing portion 170 arranged laterally adjacent the top edge of the splicer and above the display 154. The optical fibers 110,112 are positioned in the fusion splicer 100 under the fiber holding covers 172,174. Both coarse and fine alignment of the optical fibers 110,112 in the fusion splicer 100 is preferably performed automatically in response to commands issued by the PC 150 and, if present, through the CPU 102, that are executed by the position control unit 104 and the fiber positioning units 108,114,116. The fusion splicing is done automatically when the user pushes a “SPLICE START” button, such as a hard key 166 or an icon 164 on the touch screen of the display 154. The fusion splicer 100 may also be programmed to start automatically once the optical fibers 110,112 are placed into the fusion splicer under the fiber holding covers 172,174.

Before the fusion splicer 100 begins the splice process, the optical fibers 110,112 are automatically aligned using the LID system previously described. The LID system injects light into the core of at least one of the optical fibers 110,112 and monitors the optical power. As the optical fibers 110,112 are aligned with one another, the fusion splicer 100 measures the optical power transmitted through the optical fiber splice and, when the optical power is greatest, completes the splice process. The electrodes 118,120 used in the splice process are preferably Precise and Durable Electrodes that are maintenance free due to an electrode cleaning arc that ensures reliability and precision. Additionally, the electrodes 118,120 preferably have arc-stabilizers that also ensure reliability and durability.

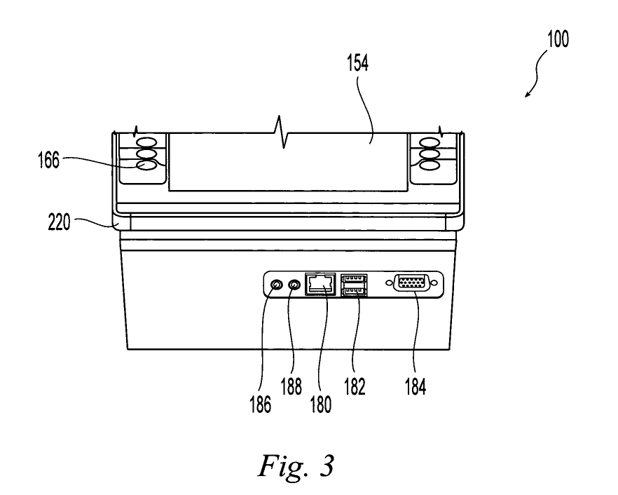

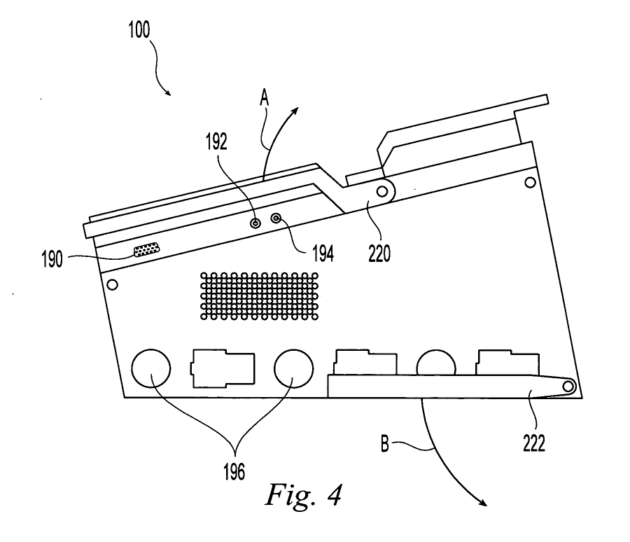

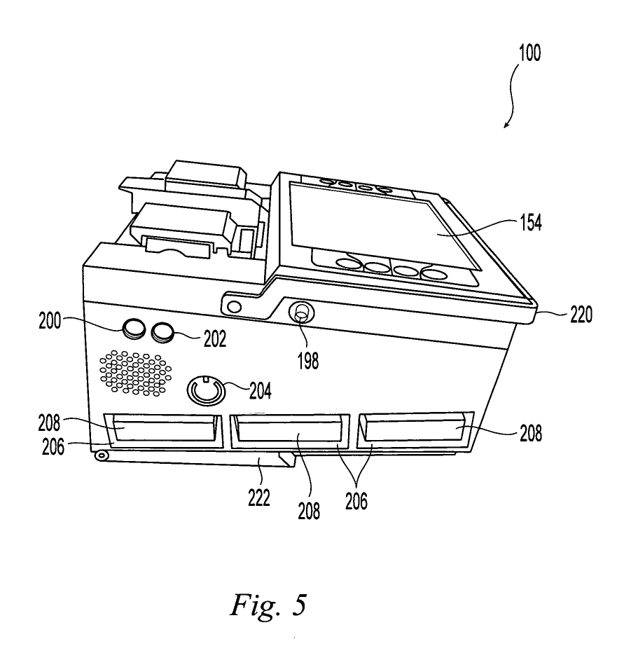

As best shown in FIG. 3, the fusion splicer 100 also includes a variety of connector ports for the PC 150 or CPU 102 located on the front of the lower portion of the field fusion splicer 100. The PC 150 preferably has an Ethernet connector port 180, at least one USB connector port 182 (1.1 and 2.0 as shown), an external VGA monitor output connector port 184, a headphone jack output connector port 186, and a microphone jack input connector port 188. As best shown in FIG. 4, the right-hand side of fusion splicer 100 preferably has a serial interface (RS232) connector port 190, an external LID transmitter connector port 192, and a video out connector port 194. While the connector ports 190,192,194 are illustrated on the right-hand side of the fusion splicer 100, they may be conveniently positioned elsewhere on the fusion splicer 100. The right-hand side of the fusion splicer 100 also has a number of access openings 196 to allow the battery packs 208 (FIG. 5) that may be used for electrical power to be pushed out for removal from the fusion splicer 100.

As best shown in FIG. 5, there may be a number of other connector ports provided on the left-hand side of fusion splicer 100. First, there is preferably a connector port 198 for an external GPS antenna (not shown). An external antenna may be used with the GPS 156 for better reception. The left-hand side may also have a connector port 200,202 for a 12V DC output to power, for example, an external heat shrink oven (not shown). A 12V DC input connector port 204 may also be provided to power the fusion splicer 100. Power from an external source may be supplied to the fusion splicer 100 through the connector port 204 from a 120V power supply (with appropriate conversion to 12V DC) or from the cigarette lighter of a vehicle. As noted above, power may also be supplied to the fusion splicer 100 by one or more batteries 208 positioned within corresponding battery ports 206. The batteries 208 are preferably rechargeable 12V 2.3Ah batteries that are able to supply sufficient power to operate the fusion splicer 100 and any related accessories.

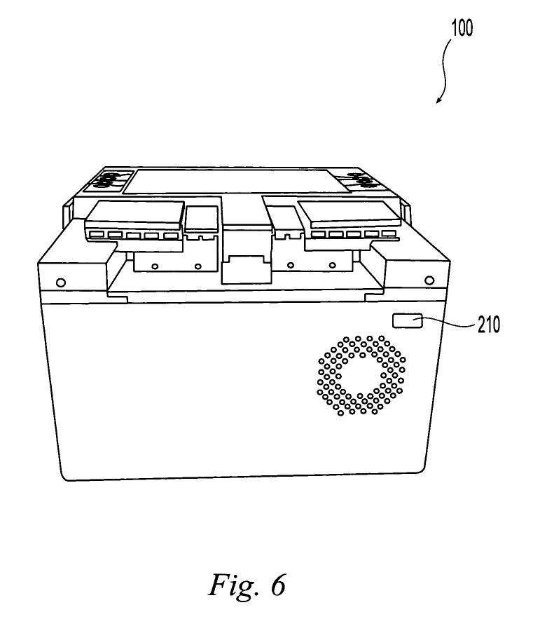

As best shown in FIG. 6, the rear of fusion splicer 100 preferably has an additional USB connector port 210 for supplying power to a USB work lamp (not shown). While in the exemplary embodiment shown and described herein the USB connector port 210 provides only power and does not have any USB functionality, it could be configured to provide either 1.1 or 2.0 USB functionality.

The Ethernet port 180 allows the PC 150 to be connected to the Internet for email communication (through appropriate application software, such as Lotus Notes®, Microsoft Outlook®, etc.), downloading upgrades to the fusion splicer operating system or application software, downloading additional application software, ordering supplies on-line, accessing on-line reference material, or connecting to a service center for real-time assistance with the splice process or GPS 156. Preferably, the service center is also able to assume control of the fusion splicer 100 via PC 150 to run diagnostics and to correct any problems that the fusion splicer 100 may experience in the field. While the connection would be slower, the fusion splicer 100 may also be connected to the Internet via an internal or external modem and corresponding application software.

The USB port 182 allows for most USB accessories to be used with the fusion splicer 100. For example, a USB memory device can be connected to the PC 150 or CPU 102 for storing and transferring data, a cellular telephone may be connected to access the Internet to transfer data or perform remote service, or a USB work lamp may be connected to operate the fusion splicer 100 in locations where there is inadequate ambient lighting.

One example of data that can be transferred from the fusion splicer 100 is the splice data that is recorded during the splice process. As noted above, the fusion splicer 100 monitors the optical power through the optical fibers 110,112 and then completes the splice when the optical power transmitted through the fibers is at a maximum. The fusion splicer 100 then measures the optical power after the splice is completed and compares it to the optical power before the splice was completed. This data can be stored on the hard drive 152 and/or transmitted back to the end user's facility or to a remote service center for assistance with the fusion splicer 100 or the splice process.

The x-axis and y-axis video systems, which are electrically connected to the PC 150, can be used as real-time video systems or may be used to record a fusion splicing event. The PC 150 would have appropriate application software stored on the hard drive 152 to allow the use of the video evaluation unit 130 to view the fusion splicing event on the display 154. The fusion splicing event or splice process may also be viewed from a remote service center or other location by one of the telecommunications methods discussed above at the same time (i.e., real time) or at a later date. The PC 150 may also simultaneously record and store the video images generated by the video evaluation unit 130 and the x-axis and y-axis video systems on the hard drive 152 for later verification and evaluation, for example on the display 154.

As noted above, the hard drive 152 may also have instructional videos stored for playback through appropriate application software on the display 154 of the PC 150, or on an external display, such as an external video monitor. This capability is advantageous because the end user may need to review the fusion splicing event or the splice process while in the field. Since it may be inconvenient or impossible to speak with a knowledgeable person at the time, the end user may play back the instructional video on the display 154 to ensure that the splice process was performed correctly. The instructional videos may also include data and/or additional information to facilitate performing maintenance on the equipment.

As previously described, the fusion splicer 100 can be battery operated and/or plugged into an electrical AC or DC outlet. The battery is preferably a rechargeable battery that can operate the fusion splicer 100 and the PC 150 for at least a couple of hours. If the location in the field allows, the fusion splicer may be plugged into a 120V AC outlet, a 12V DC cigarette lighter in a vehicle, or other auxiliary power source.

As best shown in FIG. 4, the fusion splicer 100 also includes a handle 220 that rotates in the direction indicated by arrow A and can be used to carry the fusion splicer 100 when not stored in a protective case. A stand 222 that rotates in the direction indicated by arrow B may also be provided to elevate the upper portion of the fusion splicer 100, and thereby increase the viewing angle of the display 154 and the splicing portion 170. When the stand 222 is rotated, the upper portion of the fusion splicer 100 will be elevated as best shown in FIG. 2. While the stand 222 is shown attached to the fusion splicer 100, the fusion splicer 100 could also be placed on a separate stand.

It will be apparent to those skilled in the art that various modifications and variations can be made in the field fusion splicer of the present invention without departing from the spirit or scope of the invention. Thus, it is intended that the present invention cover the modifications and variations of this invention provided they come within the scope of the appended claims and their equivalents.

1. An optical fiber fusion splicer for fusion splicing at least one pair of opposed optical fibers, the fusion splicer comprising:
a personal computer;
splicing elements in communication with and controlled by the personal computer for fusion splicing the at least one pair of opposed optical fibers; and
a display for controlling the personal computer.

2. The fusion splicer of claim 1, wherein the display includes a graphical user interface comprising a touch screen.

3. The fusion splicer of claim 1, further comprising a hard drive in communication with the personal computer for storing and retrieving data.

4. The fusion splicer of claim 1, further comprising a global positioning system adapted to interface with the personal computer.

5. The fusion splicer of claim 4, wherein the global positioning system allows the fusion splicer to compensate for differences in altitude.

6. The fusion splicer of claim 4, wherein the global positioning system allows the location of the fusion splicer to be determined from a remote location.

7. The fusion splicer of claim 4, wherein the global positioning system identifies a geographic location of a splice point.

8. The fusion splicer of claim 4, wherein the personal computer includes mapping application software and the global positioning system assists an end user to locate a splice point utilizing the mapping application software.

9. The fusion splicer of claim 1, further comprising at least one connector port to allow communication between the personal computer and a remote service center.

10. The fusion splicer of claim 9, wherein the connector port comprises an Ethernet connector port.

11. The fusion splicer of claim 1, wherein the personal computer is configured to be controlled by a user at a remote location.

12. The fusion splicer of claim 11, wherein the user at the remote location can control the splicing elements for fusion splicing the at least one pair of opposed optical fibers.

13. The fusion splicer of claim 11, wherein the user at the remote location can perform maintenance on the fusion splicer when the fusion splicer is at a location different from the remote location.

14. The fusion splicer of claim 1, wherein the personal computer is configured to receive data from a remote location.

15. The fusion splicer of claim 14, wherein the data is selected from the group consisting of operating system software, application software, splice information, operating instructions, and instructional video.

16. The fusion splicer of claim 1, wherein the personal computer communicates with a computer network at a remote location through a connector port, the connector port being selected from the group consisting of USB, Ethernet, WiFi, and modem.

17. A field fusion splicer comprising:
a personal computer;
splicing elements in communication with and controlled by the personal computer to fusion splice at least one pair of opposed optical fibers, the splicing elements being integral with the personal computer within the fusion splicer; and
a graphical user interface for controlling the personal computer.

18. A field fusion splicer comprising:
a personal computer;
a splice controller, the splice controller in communication with the personal computer; and
splicing elements controlled by the splice controller to fusion splice at least one pair of opposed optical fibers;
wherein the personal computer is integral with the splice controller and the splicing elements within the fusion splicer.

19. A field fusion splicer comprising:
a personal computer;
a splice controller, the splice controller in communication with the personal computer;
splicing elements controlled by the splice controller to fusion splice at least one pair of opposed optical fibers; and
a graphical user interface for controlling the personal computer.

20. A field fusion splicer comprising:
a personal computer;
a splice controller, the splice controller in communication with the personal computer;
splicing elements controlled by the splice controller to fusion splice at least one pair of opposed optical fibers; and
a global positioning system adapted to interface with the splice controller through the personal computer to assist with fusion splicing the at least one pair of opposed optical fibers.
